(19) United States
(12) Patent Application Publication
(10) Pub. No.: US 2017/0335794 A1
(43) Pub. Date: Nov. 23, 2017

(54) ICE STORAGE UNIT

(71) Applicant: Beyond Zero, Inc., Louisville, KY (US)

(72) Inventors: Jason S. SHERMAN, Louisville, KY (US); D. Paul HAVILAND, Louisville, KY (US); Robert L. LEWIS, JR., Louisville, KY (US); Grayson P. NEWLAND, New Albany, IN (US); Sumner E. P. ADAMS, Corydon, IN (US)

(21) Appl. No.: 15/598,944

(22) Filed: May 18, 2017

Related U.S. Application Data
(60) Provisional application No. 62/339,508, filed on May 20, 2016.

(51) Int. Cl. F02G 1/043; F02G 1/053; F02G 1/00

(52) U.S. Cl. CPC F02G 1/043; F02G 1/053; F02G 1/00

(57) ABSTRACT

An ice storage unit including a housing defining an interior portion and a heat exchange engine disposed within the interior portion, the heat exchange engine defining a thermal exchange element extending therefrom. A thermally conductive coupling element defining an aperture is sized to receive the thermal exchange element therein. A thermally conductive reservoir is disposed proximate the thermally conductive coupling element.

### CROSS-REFERENCE TO RELATED APPLICATION

This application is related to and claims priority to U.S. Provisional Patent Application Ser. No. 62/339508, filed May 20, 2016, entitled ICE STORAGE UNIT, the entirety of which is incorporated herein by reference.

### STATEMENT REGARDING FEDERALLY SPONSORED RESEARCH OR DEVELOPMENT

### TECHNICAL FIELD

The present invention relates to an ice storage unit, and in particular, relates to a unit for storing frozen adulterated liquid.

### BACKGROUND

Frozen liquids containing alcohol, sugar, or another adulterated ingredient, i.e., frozen adulterated liquids, typically have a much lower freezing point than water. For example, ethanol has a freezing point of −114 degrees Celsius, which is significantly lower than the 0 degrees Celsius freezing point of water. Thus, storing frozen adulterated liquids in standard freezers presents challenges for establishments, such as bars and restaurants, as standard commercial freezers have a freezing capacity which only reaches a temperature of −18 degrees Celsius or higher.

Furthermore, known freezers which do have capacity to reach a freezing point of −114 degrees Celsius, typically require the freezer door to remain closed in order to maintain select frozen adulterated liquids in a solid or substantially solid form, such as in the form of ice cubes. As a result of the need for the freezer door to remain closed, the frozen adulterated liquid is not readily accessible by a user, such as a server or bartender, for service to bar or restaurant patrons.

### SUMMARY

An ice storage unit is provided including a housing defining an interior portion and a heat exchange engine disposed within the interior portion. The heat exchange engine defines a thermal exchange element extending therefrom. A thermally conductive coupling element defining an aperture is sized to receive the thermal exchange element therein. A thermally conductive reservoir is disposed proximate the thermally conductive coupling element.

In another aspect of this embodiment, the ice storage unit includes a thermally conductive material sealing a portion of the thermal exchange element.

In another aspect of this embodiment, the thermally conductive material is at least one of the group consisting of a thermal paste and a thermal mastic.

In another aspect of this embodiment, the thermally conductive coupling element defines a surface including a length disposed between the thermally conductive coupling element and the thermally conductive reservoir, and the thermally conductive material spans entirely across the length of the surface.

In another aspect of this embodiment, the heat exchange engine is a Stirling engine.

In another aspect of this embodiment, the ice storage unit includes a plurality of feet coupled to the housing, the plurality of feet including a vibration damping material.

In another aspect of this embodiment, the ice storage unit includes an insulation material at least partially surrounding the thermally conductive reservoir.

In another aspect of this embodiment, the insulation material at least partially surrounds the thermal exchange element and the thermally conductive coupling element.

In another aspect of this embodiment, the ice storage unit includes a lid enclosing the thermally conductive coupling element, the lid having a sealant and a gasket coupled thereto.

In another aspect of this embodiment, the ice storage unit includes a lid enclosing the thermally conductive coupling element, the lid including a plurality of locking mechanisms coupled thereto.

In another aspect of this embodiment, the ice storage unit includes a prefabricated freezing tray sized to fit within the thermally conductive reservoir.

In another embodiment, the ice storage unit includes a housing defining an interior portion and a heat exchange engine disposed within the interior portion. The heat exchange engine defines a thermal exchange element extending therefrom and a thermally conductive coupling element defines a cavity for receiving the thermal exchange element therein. A thermally conductive material seals the thermal exchange element when the thermal exchange element is disposed within the cavity of the thermally conductive coupling element. A thermally conductive reservoir is disposed proximate the thermally conductive coupling element.

In another aspect of this embodiment, the thermally conductive material is at least one of the group consisting of a thermal paste and a thermal mastic.

In another aspect of this embodiment, the thermally conductive coupling element defines a surface including a length proximate the thermally conductive reservoir, and the thermally conductive material spans an entire length of the surface.

In another aspect of this embodiment, the heat exchange engine is a Stirling engine.

In another aspect of this embodiment, the ice storage unit includes a plurality of feet coupled to the housing, the plurality of feet including a vibration damping material.

In another aspect of this embodiment, the ice storage unit includes an insulation material at least partially surrounding the thermal exchange element, the thermally conductive coupling element, and the thermally conductive reservoir.

In another aspect of this embodiment, the ice storage unit includes a lid enclosing the thermally conductive reservoir housing, a trim ring proximate a portion of the lid, a sealant proximate the trim ring, and a gasket proximate the sealant.

In another aspect of this embodiment, the ice storage unit includes a prefabricated freezing tray sized to fit within the thermally conductive reservoir.

In another embodiment, the ice storage unit includes a housing defining an interior portion and a heat exchange engine disposed within the interior portion. The heat exchange engine defines a thermal exchange element extending therefrom and a thermally conductive coupling element defines a surface including a length and an aperture sized to receive the thermal exchange element therein. A thermally conductive material seals the thermal exchange element and the surface of the thermally conductive coupling element along the length, the thermally conductive material being at least one of the group consisting of a thermal paste and a thermal mastic. A thermally conductive reservoir is disposed proximate the surface of the thermally conductive coupling element and a prefabricated freezing tray is sized to fit within the thermally conductive reservoir. An insulation material at least partially surrounds the thermal exchange element, the thermally conductive coupling element, and the thermally conductive reservoir. A plurality of feet and a lid are coupled to the housing, the plurality of feet including a vibration damping material.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a front view of an ice storage unit in accordance with the present invention;

FIG. 2 is a front cross-sectional view of the ice storage unit taken across section A-A of FIG. 1;

FIG. 3 is a perspective view of a thermally conductive coupling element of the ice storage unit of FIG. 1;

FIG. 4 is a perspective view of the ice storage unit of FIG. 1;

FIG. 5 is an exploded side cross-sectional view of the ice storage unit of FIG. 1 taken across section B-B of FIG. 4;

FIG. 6 is an elevational side view of an inner portion of the ice storage unit of FIG. 1; and

FIG. 7 is perspective view of the partially disassembled ice storage unit of FIG. 1.

### DETAILED DESCRIPTION

As used here, relational terms, such as “first” and “second,” “top” and “bottom,” “front and rear,” and the like, may be used solely to distinguish one entity or element from another entity or element without necessarily requiring or implying any physical or logical relationship or order between such entities or elements.

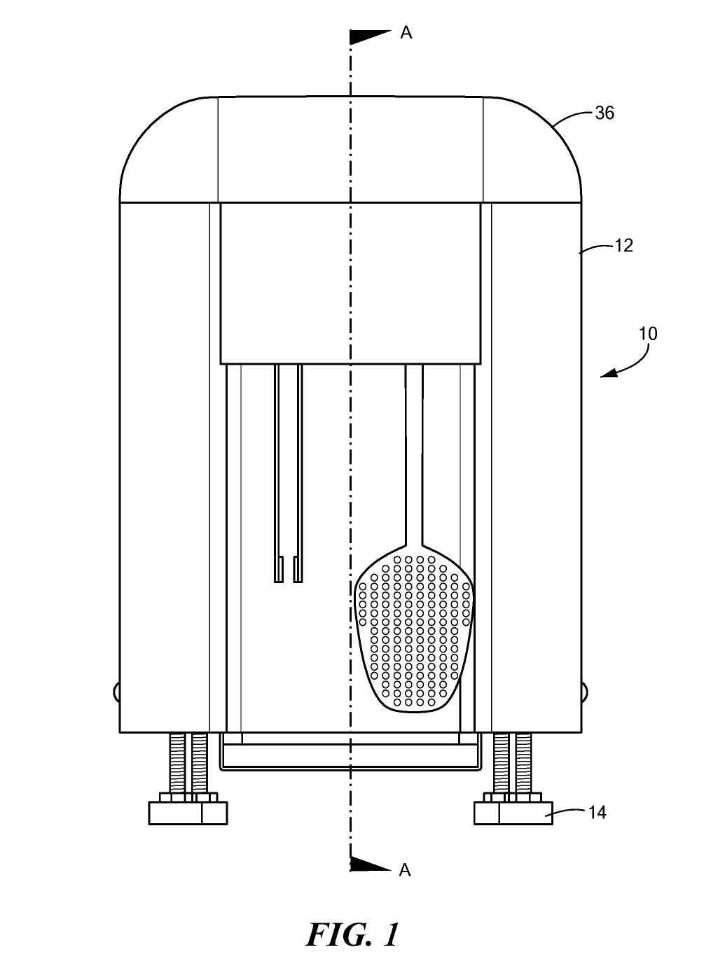

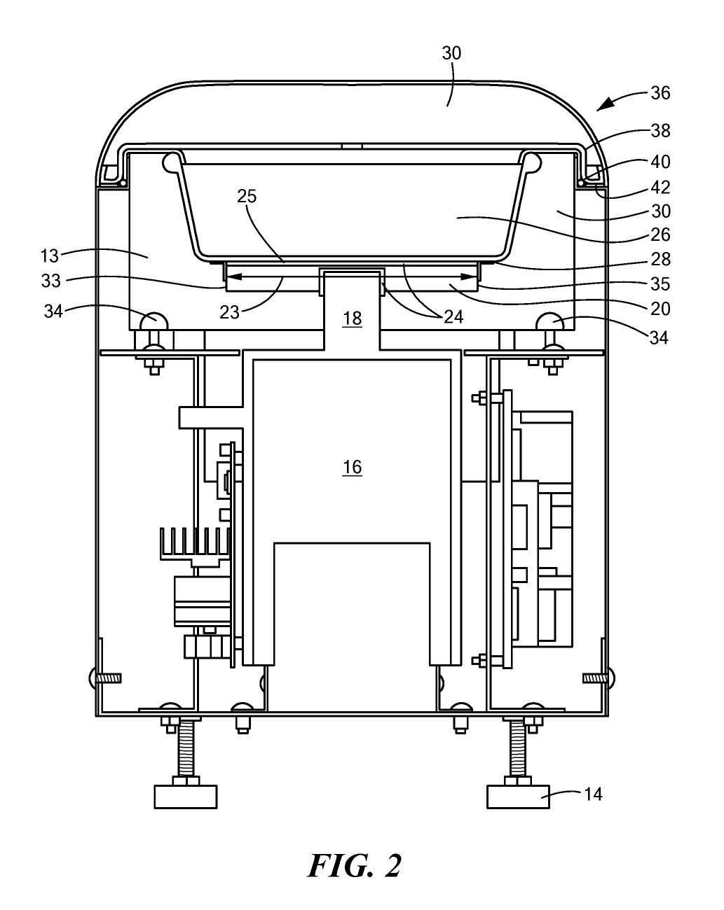

Referring now to the drawings in which like reference designators refer to like elements there is shown in FIG. 1 an exemplary ice storage unit constructed in accordance with the principles of the application and designated generally as “10.” The ice storage unit 10 is configured to store frozen liquid containing alcohol, sugar, and/or other adulterated ingredients. For example, the ice storage unit 10 may be configured to store the frozen adulterated liquid in the form of ice cubes. The ice storage unit 10 may generally include a housing 12 defining an interior 13 (as illustrated in FIG. 2) for storing the various components of the ice storage unit 10 therein. The housing 12 may be any size or shape suitable to fit on a counter-top, for example, a standard counter top in a bar or restaurant where alcoholic beverages are served.

With reference to FIGS. 1 and 2, the housing 12 may include four feet 14 constructed using a vibration damping material, such as a viscoelastic polymer, rubber, or another material having a high damping coefficient, configured to resonate at a same or substantially the same frequency as a heat exchange engine 16 retained within the housing 12 to dampen vibrations caused by the heat exchange engine 16. In one exemplary configuration, the heat exchange engine 16 is a Stirling engine, such as an 80 W free piston Stirling engine. An alternative type of heat exchange engine or heat pump known in the art may also be used, for example, a thermosiphon, compressor, or chemical based heat exchange device, which actively extracts heat from one location and transfers the heat to another location.

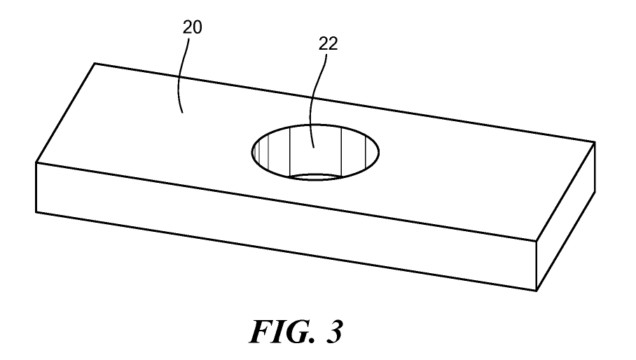

As shown in FIG. 2, depicting a front cross-sectional view of the ice storage unit taken across section A-A of FIG. 1, the heat exchange engine 16 defines a thermal exchange element 18 extending therefrom, which is in thermal communication with a thermally conductive coupling element 20. The thermal exchange element 18 may protrude a distance away from a cylindrical portion of the heat exchange engine 16. The distance may vary according to the overall dimensions of the heat exchange engine 16. As depicted in FIG. 3, the thermally conductive coupling element 20 may define an aperture or cavity 22 sized to receive the thermal exchange element 18 therein. The thermally conductive coupling element 20 may be composed of a rigid metal, metal alloy, or any rigid conductive element, such as aluminum, copper, stainless steel, and like alloys.

During operation of the heat exchange engine 16, at least a portion of the thermal exchange element 18 becomes cold as the heat exchange engine 16 extracts heat from the thermal exchange element 18 and the thermally conductive coupling element 20. In one exemplary configuration, the heat exchange engine 16 is configured to lower the temperature of the thermal exchange element 18 and the thermally conductive coupling element 20 to between −100 degrees Celsius and −25 degrees Celsius, although temperatures lower than −100 degrees Celsius may also be achieved.

Disposed between the thermally conductive coupling element 20 and the thermal exchange element 18 may be a thermally conductive material 24 coupling the portion of the thermal exchange element 18 disposed within the aperture 22 to the thermally conductive coupling element 20. The thermally conductive material 24 may be a thermal paste or a thermal mastic that is applied to an exterior surface of the portion of the thermal exchange element 18 disposed within the aperture 22. The thermally conductive material 24 provides a highly thermal conductive layer between respective conductive components to further enhance heat exchange and improve heat exchange losses. The thermally conductive material 24 may also assist with the thermal exchange element 18 adhering to the thermally conductive coupling element 20.

In one exemplary embodiment, the thermally conductive material 24 may also couple the thermally conductive coupling element 20 to a thermally conductive reservoir 26, such as an ice reservoir, disposed proximate the thermally conductive coupling element 20. The thermally conductive material 24 may be disposed across a length 23 of a surface 25 of the thermally conductive coupling element 20 to create a tight seal between the reservoir 26 and the thermally conductive coupling element 20. For example, the thermally conductive material 24 may extend across an entire length or at least 60% of the length 23 of the thermally conductive coupling element 20 from a first side 33 to a second side 35 of the thermally conductive coupling element 20. The thermally conductive material 24 may also be disposed on a surface of the reservoir 26 in contact with the surface 25 of the thermally conductive coupling element. In one exemplary configuration, an adhesive 28, such as aluminum tape, may also be used to couple the reservoir 26 to the thermally conductive coupling element 20.

The reservoir 26 may be composed of a thermally conductive material, for example, aluminum or stainless steel. The reservoir 26 stores frozen adulterated liquid, such as in the form of frozen ice cubes, within the reservoir 26. For example, the reservoir 26 may store up to 2 liters of solid ice cubes or approximately 120-160 ice cubes, with each ice cube containing approximately 0.25 ounces of 20 to 120 proof alcohol, as a result of the efficiency of the heat exchange engine 16. More or less frozen adulterated liquid may be stored, depending upon the size of the reservoir 26 and the efficiency of the heat exchange engine 16.

Referring still to FIG. 2, an insulation 30, for example, foam, gel, aerogel, or another material with a high thermal insulating capability (R-value), may be disposed within the housing 12 to at least partially surround the thermal exchange element 18, the thermally conductive coupling element 20, and the reservoir 26. For example, the insulation 30 may surround at least two sides of the thermal exchange element 18, the thermally conductive coupling element 20, and the reservoir 26 to reduce or maintain the temperature of the thermal exchange element 18 and the thermally conductive coupling element 20 to between −100 degrees Celsius and −25 degrees Celsius, or lower in some instances. The insulation 30 may also fit securely around the reservoir 26 to firmly secure the reservoir 26 within the housing 12. Said another way, the reservoir 26 may be coupled to the housing 12 through the insulation 30. In addition to the insulation 30, one or more connectors 34, for example, screws, may be used to mechanically connect the housing 12 to the reservoir 26. Alternatively, a collar or other releasable connector may be used to mount the reservoir 26 to the housing 12.

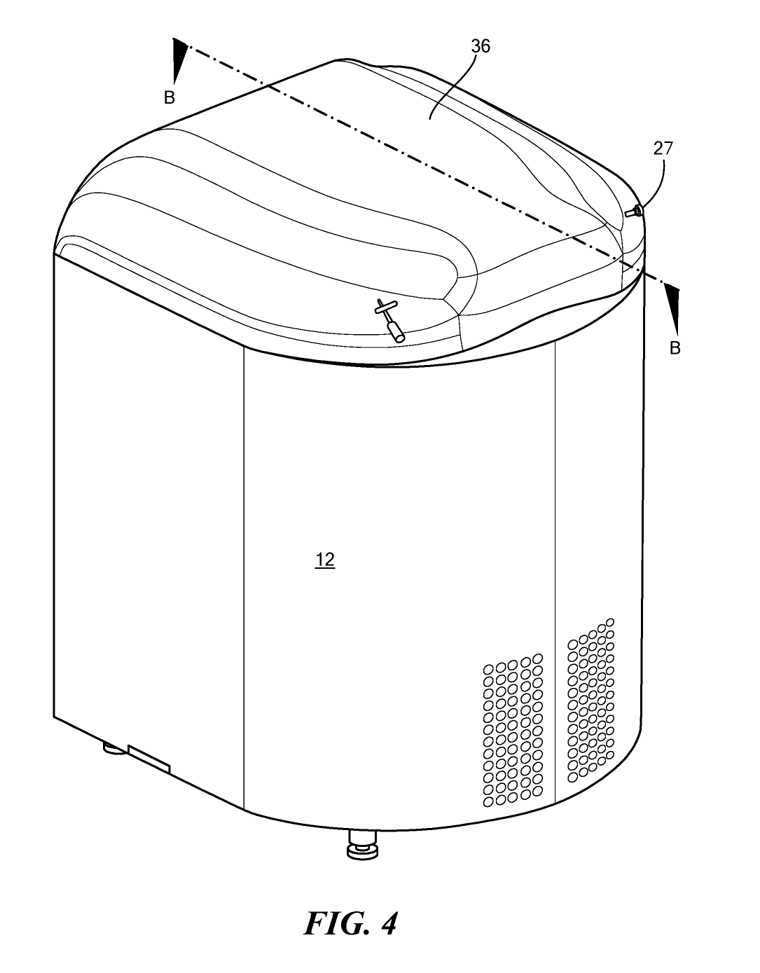

Referring to FIGS. 4-6, in one exemplary configuration, in order to decrease the temperature within the reservoir 26, a lid 36 may be coupled to the housing 12 to releasably seal and thermally insulate the reservoir 26. The lid 36 may entirely enclose the reservoir 26 or an opening (not shown) may be formed in the lid 36 to receive a locking cable 27 through the opening to close and lock the lid 36, as discussed in further detail below.

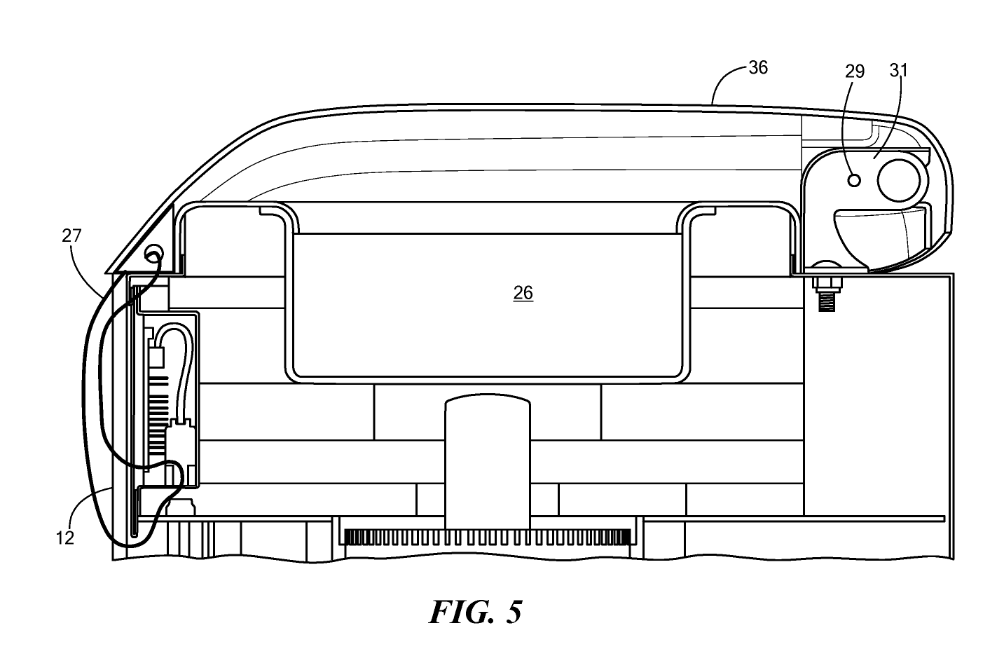

The lid 36 may be composed of a thermoplastic polymer, for example, ABS, or another suitable material for thermally insulating the reservoir 26. Referring to FIG. 5, the lid 36 may be closed and locked using one or more locking mechanisms. For example, the locking cable 27 may be disposed on one side of the housing 12 and a locking pin 29 fastened within a hinge lock 31 may be disposed on an opposing side of the housing 12 to lock the lid 36. In order to access the ice cubes within the reservoir 26, the locking pin 29 may be disengaged from the hinge lock 31 to rotate the lid 36 or the lid 36 may be entirely removable from the housing 12. The insulation 30, an ABS trim ring 38, a sealant 40, such as silicon, and a gasket 42 may be provided proximate to each other at a base of the lid 36 to prevent condensation and water vapor seepage from outside of the reservoir 26.

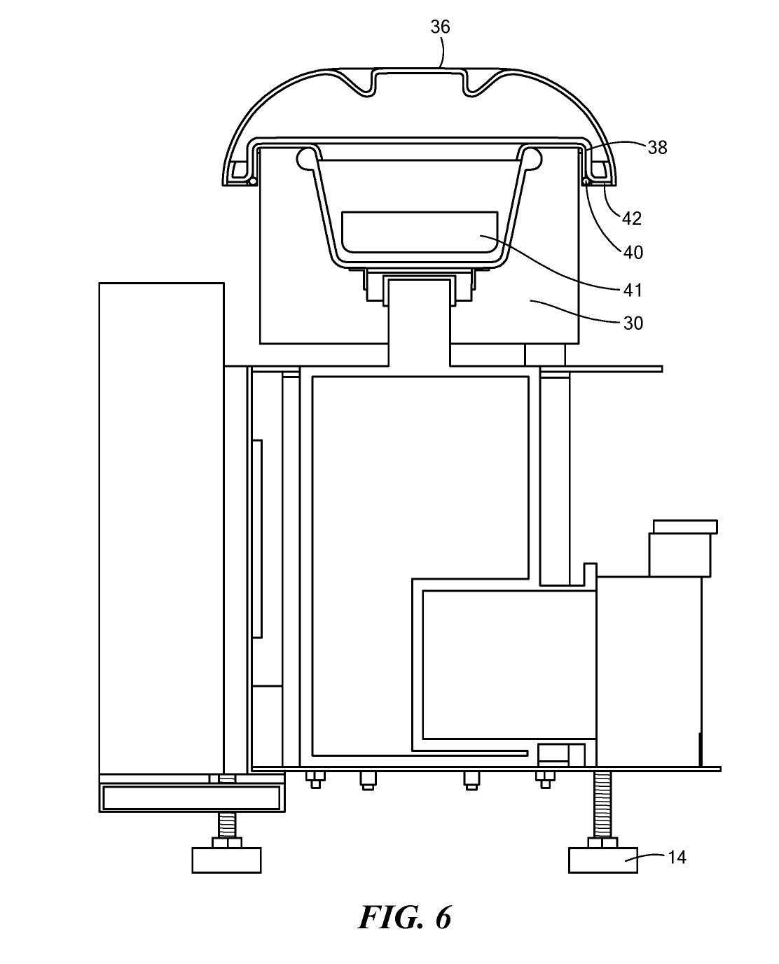

Referring still to FIG. 6, a prefabricated freezing tray 41 may be disposed within the reservoir 26 to freeze frozen adulterated liquid poured within the freezing tray 41. The frozen adulterated liquid may be poured within the freezing tray 41 before or after the freezing tray 41 is placed within the reservoir 26. In one exemplary embodiment, the freezing tray 41 is constructed using a silicon material capable of sustaining the freezing temperatures of the unit 10, without the frozen adulterated liquid adhering to the freezing tray 41. The freezing tray 41 may also be constructed using rubber, aluminum, stainless steel, and the like. The freezing tray 41 may be round, square, rectangular, or another suitable shape sized to fit within the reservoir and hold at least 1-2 fluid ounces therein. Upon freezing, the frozen adulterated liquid may be extracted from the freezing tray 41 for consumption.

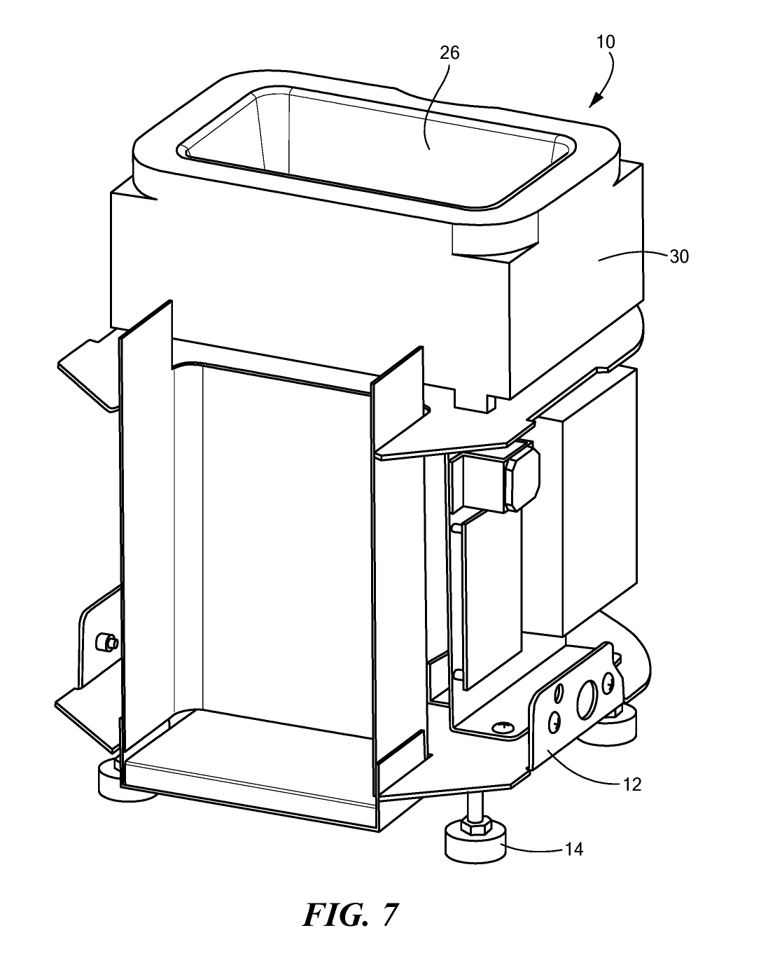

In one exemplary configuration, as depicted in FIG. 7, the reservoir 26 may include an open-top design which provides a server or bartender with the ability to readily access the ice cubes and/or the freezing tray 41 (FIG. 6) within the reservoir 26 without the need to open or remove the lid 36. The open-top design, however, may be interchanged with the lid 36.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings.

What is claimed is:

1. An ice storage unit, comprising:
a housing defining an interior portion;
a heat exchange engine disposed within the interior portion, the heat exchange engine defining a thermal exchange element extending therefrom;
a thermally conductive coupling element defining an aperture sized to receive the thermal exchange element therein; and
a thermally conductive reservoir disposed proximate the thermally conductive coupling element.

2. The ice storage unit of claim 1, further comprising a thermally conductive material sealing a portion of the thermal exchange element.

3. The ice storage unit of claim 2, wherein the thermally conductive material is at least one of the group consisting of a thermal paste and a thermal mastic.

4. The ice storage unit of claim 2, wherein the thermally conductive coupling element defines a surface including a length disposed between the thermally conductive coupling element and the thermally conductive reservoir, and the thermally conductive material spans entirely across the length of the surface.

5. The ice storage unit of claim 1, wherein the heat exchange engine is a Stirling engine.

6. The ice storage unit of claim 1, further comprising a plurality of feet coupled to the housing, the plurality of feet including a vibration damping material.

7. The ice storage unit of claim 1, further comprising an insulation material at least partially surrounding the thermally conductive reservoir.

8. The ice storage unit of claim 1, further comprising an insulation material at least partially surrounding the thermal exchange element and the thermally conductive coupling element.

9. The ice storage unit of claim 1, further comprising a lid enclosing the thermally conductive coupling element, the lid having a sealant and a gasket coupled thereto.

10. The ice storage unit of claim 1, further comprising a lid enclosing the thermally conductive coupling element, the lid including a plurality of locking mechanisms coupled thereto.

11. The ice storage unit of claim 10, further comprising a prefabricated freezing tray sized to fit within the thermally conductive reservoir.

12. An ice storage unit, comprising:
a housing defining an interior portion;
a heat exchange engine disposed within the interior portion, the heat exchange engine defining a thermal exchange element extending therefrom;
a thermally conductive coupling element defining a cavity for receiving the thermal exchange element therein;
a thermally conductive material sealing the thermal exchange element when the thermal exchange element is disposed within the cavity of the thermally conductive coupling element; and
a thermally conductive reservoir disposed proximate the thermally conductive coupling element.

13. The ice storage unit of claim 12, wherein the thermally conductive material is at least one of the group consisting of a thermal paste and a thermal mastic.

14. The ice storage unit of claim 12, wherein the thermally conductive coupling element defines a surface including a length proximate the thermally conductive reservoir, and the thermally conductive material spans an entire length of the surface.

15. The ice storage unit of claim 12, wherein the heat exchange engine is a Stirling engine.

16. The ice storage unit of claim 12, further comprising a plurality of feet coupled to the housing, the plurality of feet including a vibration damping material.

17. The ice storage unit of claim 12, further comprising an insulation material at least partially surrounding the thermal exchange element, the thermally conductive coupling element, and the thermally conductive reservoir.

18. The ice storage unit of claim 12, further comprising:
a lid enclosing the thermally conductive reservoir housing;
a trim ring proximate a portion of the lid;
a sealant proximate the trim ring; and
a gasket proximate the sealant.

19. The ice storage unit of claim 12, further comprising a prefabricated freezing tray sized to fit within the thermally conductive reservoir.

20. An ice storage unit, comprising:
a housing defining an interior portion;
a heat exchange engine disposed within the interior portion, the heat exchange engine defining a thermal exchange element extending therefrom;
a thermally conductive coupling element defining a surface including a length and an aperture sized to receive the thermal exchange element therein;
a thermally conductive material sealing the thermal exchange element and sealing the surface of the thermally conductive coupling element along the length, the thermally conductive material being at least one of the group consisting of a thermal paste and a thermal mastic;
a thermally conductive reservoir disposed proximate the surface of the thermally conductive coupling element;
a prefabricated freezing tray sized to fit within the thermally conductive reservoir;
an insulation material at least partially surrounding the thermal exchange element, the thermally conductive coupling element, and the thermally conductive reservoir;
a plurality of feet coupled to the housing, the plurality of feet including a vibration damping material; and
a lid coupled to the housing.
